(19) United States
(12) Patent Application Publication
(10) Pub. No.: US 2024/0077448 A1
(43) Pub. Date: Mar. 7, 2024

(54) Gas Permeable Electrode

(71) Applicant: Matrix Sensors, Inc., San Diego, CA (US)

(72) Inventors: Ignacio Luz Minguez, Alameda, CA (US); Michel Chen, San Diego, CA (US)

(73) Assignee: Matrix Sensors, Inc., San Diego, CA (US)

(21) Appl. No.: 18/242,027

(22) Filed: Sep. 5, 2023

Related U.S. Application Data
(60) Provisional application No. 63/403,698, filed on Sep. 2, 2022.

(51) Int. Cl. G01N 27/22

(52) U.S. Cl. CPC G01N 27/225; G01N 29/036

(57) ABSTRACT

The disclosure provides a gas permeable electrode and method for making the electrode to create diffusion pathways (or pores) in the metal electrode in a manner that is not destructive to delicate or soft sensing material. A first polymer, which is gas-permeable, is applied as a continuous coating over a surface of the sensing material. A second polymer that is immiscible with the first polymer is applied over a surface of the first polymer (e.g., spray-dry deposition of the second polymer) to form a micro-pattern or a polymeric template. The incompatibility/immiscibility between the first polymer and the second polymer leads to segregation of the second polymer into a pattern of discontinuous bumps, dots, islands or blobs on top of the first polymer. The porous electrode comprises at least one layer of an electrically conductive metal that is deposited over the first and second polymers. Bumps of the second polymer promotes small cracks or voids in the metal electrode layer that enable fast diffusion of analytes through the electrode.

### CROSS REFERENCE TO RELATED APPLICATIONS

This application claims the benefit of U.S. provisional patent application 63/403,698 filed on Sep. 2, 2022 which application is hereby incorporated by reference in its entirety.

### BACKGROUND

The invention relates generally to gas-permeable or porous metal electrodes, and in particular to a gas permeable electrode and method for producing the electrode that is suitable for use with a sensor having a delicate or soft sensing material (e.g., a metal-organic framework).

Chemical sensing of gases is an important technology in several fields including environmental monitoring, industrial safety, and public security. In particular monitoring air quality for the health, safety and well being of consumers is receiving considerable interest. The ability to detect chemical vapors, especially volatile organic compounds (VOCs), is important in many applications including environmental monitoring and the like.

Many methods for the detection of chemical analytes have been developed including, for example, optical, gravimetric, and microelectromechanical (MEMS) methods. In particular, sensors that monitor electrical properties such as capacitance, impedance, resistance, etc., have been developed. Often, such sensors rely on the change that occurs in the electrical properties of a sensing material upon adsorption or absorption of an analyte into the material.

Gas permeable electrodes are essential to facilitate the diffusion of gases into a porous gas/liquid sensing material intercalated within a capacitor sensor device. The low permeability of gases/liquid or analytes/adsorbates across dense metal-based conductive materials (acting as electrodes) drastically limits the response-time of the sensor.

Several approaches has been reported for creating diffusion channels (or pores) in the metal electrodes, including patterning/etching methodologies, which commonly involve destructive techniques such as template digestion with harsh chemicals (i.e., base and acids) or plasma etching. These destructive techniques are not very size-precise or chemically-selective which can often damage the sensing material, especially when the sensing materials are porous, soft and/or displayed in thin films (e.g., thickness of a few microns). Some existing approaches for creating porous electrodes require the assembly of top patterned masks/templates prior to metal deposition. This approach presents several challenges, such as lower physical limits for pattern dimensions on the mask (over 10s of microns), scratching of the sensing material film, and blurriness of the metal pattern deposited due to resulting macroscopic film-mask spacing upon assembly.

There is still a need for a simple, low cost, gas-permeable electrode that overcomes these problems.

### SUMMARY

According to an aspect, a method for fabricating a gas permeable electrode comprises coating a sensing material with at least one layer of a first polymer that is gas-permeable. Bumps, blobs or islands of a second polymer are placed on a surface of the first polymer. At least one layer of an electrically conductive metal is deposited over the bumps of the second polymer and the exposed surface area of the first polymer between the bumps to form the metal electrode. The resulting metal electrode has cracks, voids, discontinuities, interstices, holes or pores caused by the interaction of the deposited metal layer with the bumps of the second polymer (e.g., due to the expansion/contraction of a flexible, porous, and soluble material such as the second polymer within a rigid and insoluble coating or shell of the deposited metal layer, and the differences of the expansion coefficient of the two different materials). In some embodiments, the assembly is exposed to moisture (e.g., in the atmosphere or ambient air) to cause swelling of the blobs or bumps of the second polymer, and to promote larger cracks, voids, discontinuities, interstices, holes or pores in the metal electrode. In some embodiments, the bumps, blobs or islands of the second polymer are removed or reduced in size (e.g., dissolved chemically, shaved or flattened mechanically, or thermally evaporated) after causing the cracks, voids, discontinuities, interstices, holes or pores in the metal electrode.

According to another aspect, a sensor element comprises a sensing material (e.g., a porous crystalline material) and at least one layer of a first polymer coating the sensing material. The first polymer is sufficiently gas-permeable to permit molecules of analyte to pass through to the sensing material. Bumps, islands or blobs of a second polymer are disposed on the layer of the first polymer (e.g., in a pattern of substantially discontinuous bumps or blobs of the second polymer). At least one layer of an electrically conductive metal is deposited over the bumps of the second polymer and exposed areas of the first polymer between the bumps to form a metal electrode. The metal layer has voids, cracks, discontinuities, pores or holes caused by the bumps or blobs of the second polymer. In some embodiments, the bumps or blobs of the second polymer are removed or reduced in size (e.g., dissolved chemically, shaved or flattened mechanically, or thermally evaporated) after the bumps or blobs cause the cracks, voids, discontinuities, pores or holes in the metal electrode.

### BRIEF DESCRIPTION OF THE DRAWINGS

The foregoing aspects and advantages of the present invention will become better understood upon reading the following detailed description and upon reference to the drawings where:

FIG. 1 is a top plan view of a resonant sensor and a parallel plate capacitor according to a first embodiment of the invention.

FIG. 2 is a schematic, side view of a mechanical resonator and a capacitor sharing a common electrode.

FIG. 3 is a schematic, side view of a capacitor disposed on an oscillating portion of a resonant sensor according to another embodiment of the invention.

FIG. 4 is a schematic block diagram of a readout circuit connected to a sensor element having three electrodes.

FIG. 5 is a schematic block diagram of a readout circuit connected to a sensor element having four electrodes, according to another embodiment.

FIG. 6 is a schematic block diagram of readout circuits communicating with a processor that outputs calculated analyte and humidity values.

FIG. 7 is an exploded view of a sensor element comprising a resonator and a capacitor sharing a common electrode.

FIG. 8 is a schematic, top plan view of blobs or bumps of a polymer patterned on a continuous layer of another polymer.

FIG. 9 is a schematic, top plan view of a polymer blob or bump disposed on a continuous layer of a different polymer.

FIG. 10 is a schematic, side view of a polymer blob or bump positioned on a continuous layer of a different polymer, showing a hollow morphology of the blob or bump.

FIGS. 11A-11D are SEM images of a layer of metal deposited over a polymer template.

FIG. 12 is an SEM image of bumps, islands, or blobs of a polymer patterned on a continuous layer of a different polymer.

FIG. 13 is another SEM image of bumps, islands, or blobs of a polymer patterned on a continuous layer of a different polymer.

FIG. 14 is a further SEM image of bumps, islands, or blobs of a polymer patterned on a continuous layer of a different polymer.

FIG. 15 is a schematic, plan view of a capacitive sensor having a gas permeable electrode.

FIG. 16 is a schematic, plan view of holes formed in a metal electrode, according to some embodiments.

### DETAILED DESCRIPTION OF PREFERRED EMBODIMENTS

In the following description, it is understood that all recited connections between structures can be direct operative connections or indirect operative connections through intermediary structures. An element includes one or more elements. Any recitation of an element is understood to refer to at least one element. A plurality of elements includes at least two elements. Unless otherwise required, any described method steps need not be necessarily performed in a particular illustrated order. A first element (e.g. a signal or data) derived from a second element encompasses a first element equal to the second element, as well as a first element generated by processing the second element and optionally other signals or data. Making a determination or decision according to (or in dependence upon) a parameter encompasses making the determination or decision according to the parameter and optionally according to other signals or data. Unless otherwise specified, an indicator of some quantity/data may be the quantity/data itself, or an indicator different from the quantity/data itself such as a signal from which the quantity/data can be determined.

Resonant sensors use a sensing material to capture (e.g., adsorb or absorb) one or more analytes (e.g., target molecules) that change properties that are reflected in a mechanical or electromechanical response of the sensor, such as a frequency shift or a change in resonance frequency, dissipation, quality factor, stiffness, or strain. The response of the resonant sensor is often detected using an electrical property, such as a change in impedance of the circuit driving an oscillating motion of the sensor. Many electrical detection methods and optical detection methods are known in the art to detect a frequency shift or a change in resonance frequency, dissipation, quality factor, stiffness, or strain of a resonant sensor or array of resonant sensors. Similarly, capacitive sensors also employ a sensing material (placed between two electrodes) to capture a target analyte that changes the capacitance of the sensor element upon adsorption or absorption of the analyte.

A wide variety of cantilever, membrane and piezoelectric resonator-based sensors have been fabricated using Micro-Electro-Mechanical Systems (MEMS) technology. These sensors generally detect substances through the use of sensing material (e.g., a polymer film or a metal-organic framework) with selective adsorption for a specific analyte (e.g., molecules of the gas of interest). Resonant sensors are sensitive to small amounts of water vapor even at moderate levels of relative humidity. When measuring an analyte in ambient conditions, the sensor may indicate a mass change not only due to the target gas, but also due to the additional adsorption of water molecules in the sensing material.

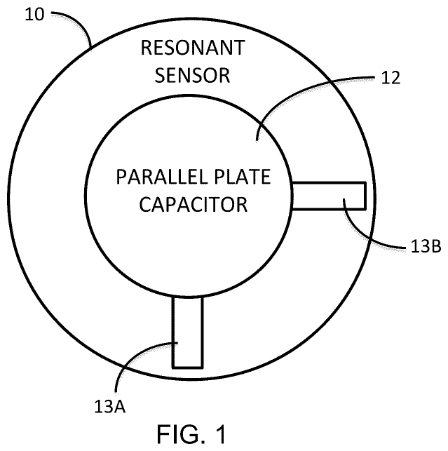

FIG. 1 shows a resonant sensor 10 and a parallel-plate capacitor 12 that is positioned on the oscillating portion of the resonant sensor 10. The resonant sensor 10 is preferably a quartz crystal microbalance (QCM). There are many other mechanical resonators suitable for use including but not limited to cantilevers, capacitive micromachined ultrasonic transducers (cMUTs), Piezoelectric Micromachined Ultrasonic Transducers (PMUT), thin-film bulk acoustic resonator, or other transducers. The quartz crystal typically has a circular surface, and the parallel-plate capacitor 12 is positioned on the oscillating portion of the QCM substantially at the center of the circular surface. The capacitor is formed by two electrodes having respective electrical contact pads 13A, 13B.

The capacitor 12 provides a capacitance measurement that is useful to determine the amount of water vapor that is captured in the sensing material on the resonant sensor 10. The capacitance measurement is combined with the measurement of the mechanical or electromechanical response of the resonant sensor 10, such as a frequency shift or a change in resonance frequency, dissipation, quality factor, stiffness, or strain. This combination of electromechanical and capacitance measurements enables the device to distinguish between various types of molecules captured in the sensing material, especially distinguishing between an analyte of interest (e.g., carbon dioxide or methane) and water molecules that might interfere with the detection of the analyte. The capacitance measurement is useful to determine how much of the response of the resonator is due to water, and thus how much of the response of the resonator is due to a mass of analyte in the sensing material.

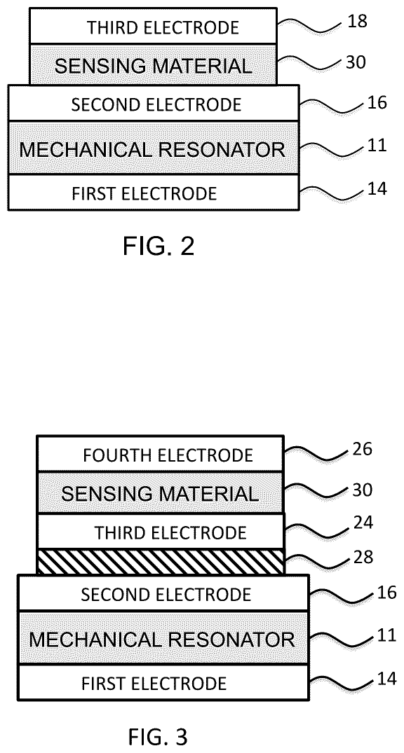

FIG. 2 shows a side view of a sensing element that includes a mechanical resonator 11 (e.g., a quartz crystal), a first (back) electrode 14 coupled to a back side of the resonator 11, and a second (front) electrode 16 that is coupled to a front side of the resonator 11. The first and second electrodes 14 and 16 are positioned to apply a potential difference across the resonator 11 to drive an oscillating motion of the resonator 11. The first and second electrodes 14 and 16 are composed of an electrically conductive metal (e.g., gold). A sensing material 30 is disposed on the second electrode 16. The sensing material 30 at least partially covers the second (front) electrode 16. In some embodiments, the sensing material 30 covers the electrode 16 completely, although complete coverage is not necessary. The layer of the sensing material 30 on the second electrode 16 should be sufficient to capture enough analyte (if present in the environment or sample to which the resonant sensor is exposed) to change the oscillation of the resonant sensor due to the mass of the analyte adsorbed. The sensing material 30 is preferably an adsorbing film (e.g., a metal-organic framework or a polymer film) that is grown or deposited directly on the front electrode 16.

The parallel-plate capacitor is formed by the second electrode 16 and a third electrode 18 with the sensing material 30 positioned between the second and third electrodes. If the resonator 11 is a QCM, the first electrode 14 is the back electrode, and the second electrode 16 is the front electrode. The second (front) electrode 16 is preferably grounded, and the capacitor shares the grounded second electrode 16 with the resonator 11 in this embodiment. The third electrode 18 should be gas-permeable (e.g. porous) to ensure that the sensing material 30 is accessible to analyte molecules in a sample or in the environment to which the sensor is exposed.

The sensing material 30 is preferably a porous crystalline material such as a metal-organic framework (MOF), porous coordination polymer, or porous coordination framework. MOF subclasses include Zeolitic imidazolate framework (ZIF), IRMOF, and Multivariate MOF (MTV-MOF) made using a mix of organic linkers having the same geometry but varied chemical functionality. Suitable porous crystalline materials also include a covalent organic framework (COF) in which the framework includes covalent chemical bonds rather than metal coordination bonds, or Zeolite which is a class of inorganic porous crystalline materials. In rare embodiments, the porous sensing materials comprise non-crystalline porous materials such as Metal-organic Polyhedron having discreet porous cages, Porous metal-organic polymer, Metal-organic gel, or Porous Carbon (also known as activated carbon).

Metal-organic frameworks (MOFs) are an expanding class of porous crystalline materials that are built up from nodes of metal ions connected by organic linkers. MOFs with varying pore sizes can selectively adsorb molecules based on the size of the molecules. For example, engineered MOFs with pore sizes designed for carbon dioxide (CO₂) adsorption can separate gases in industrial processes. MOFs can also be used as sensing material with a QCM to act as a chemical sensor in controlled environments. When one or more types of MOFs is used as a sensing material on a resonant sensor, the surface on which the MOF is grown may be prepared for MOF growth with a self-assembled monolayer (SAM) or by deposition of either an oxide or metal surface. The MOF coating on the oscillating portion of the sensor typically has a thickness in the range of 1 to 10,000 nm. MOFs can be designed with different pore sizes and specific chemical affinities to target specific gases with high selectivity.

In other embodiments, the sensing material 30 is a polymer film. Polymer sensing materials respond to gas-phase analytes in a time frame of seconds to tens of minutes. The selection of the polymer sensing material is preferably optimized to fit the mechanical properties of the resonator (elasticity, density, thickness, etc.), so that detection time is minimized and sensitivity is maximized. Sensors may be coated or functionalized with various types of sensing materials for specific applications. These possible sensing materials include, for example, porous receptor materials as listed above, polymers (co-polymers, bio-polymers), sol gels, and DNA, RNA, proteins, cells, bacteria, carbon nanotube arrays, catalysts including metals to enzymes, nanoclusters, organic and inorganic materials including: supramolecules, metal-organic complexes, or dendritic materials.

The second and third electrodes 16 and 18 preferably comprise substantially parallel layers or plates of metal, and a layer of the sensing material 30 is positioned between the parallel layers or plates of metal. The electrodes typically include respective electrical contact pads 13A, 13B (shown in FIG. 1 but not shown in FIG. 2). The third electrode 18 is gas-permeable (e.g., there are cracks, voids, discontinuities, interstices, holes or pores in the electrode to permit molecules of a target gas or liquid to pass through the electrode and into the sensing material 30).

It is not necessary for the entire portion of each electrode to be a parallel plate that is fully intact, since the contact pad, holes, or other parts of each electrode may not exactly resemble a parallel plate. Instead, it is preferred that each of the electrodes 16 and 18 has a major portion that is at least one layer of metal (that may include holes to be gas-permeable) that lies in a plane substantially parallel to the plane of the other electrode. Each electrode may include some other parts (e.g., electrical contact pads) that are not necessarily part of the parallel layer of metal. The contact pads preferably extend outwardly from the major portions of the electrodes to the edges or the non-oscillating portion of the quartz crystal. The contact pads may connect to the holder of the quartz and they turn into vias or larger pads, as is known in the art. The sensing element may include other variations of capacitor designs which may include guard rings, etc.

The capacitor formed by the second and third electrodes 16, 18 is positioned on the oscillating portion of the resonator 11. The term “oscillating portion” is intended to mean the portion, region, or member of the resonator that oscillates. For example, the oscillating portion for a QCM typically comprises the piezoelectric material vibrating between the first and second electrodes 14 and 16. For a cantilever type of resonant sensor, the oscillating portion is the cantilever beam and the capacitor is positioned on the beam. For a cMUT type of resonant sensor, the oscillating portion is typically a vibrating membrane and the capacitor is positioned on the membrane. With a bulk acoustic resonator, the oscillating portion typically comprises the piezoelectric material and the electrodes positioned to apply a potential difference across the piezoelectric material, etc.

The positioning of the capacitor on the oscillating portion of the resonator 11 enables the sensor element to measure the mechanical or electromechanical response to the mass of substances (e.g., the analyte of interest and water) that are captured in the sensing material 30 and to measure the capacitance change due to the capture of substances in the same sensing material 30 at the same temperature and point in time. The capacitance measurement indicates how much of the response of the resonator 11 (e.g., frequency shift or change in resonance frequency, stiffness or strain) is due to water in the sensing material 30, and thus how much of the response of the resonator 11 is due to an amount of the target analyte captured in the sensing material 30.

Water has a much higher relative permittivity than the analyte of interest, so that the presence of water in the sensing material 30 changes the capacitance measurement, while the presence of molecules of the target gas often has a negligible effect on the capacitance measurement due to the much lower relative permittivity of the analyte. Water typically has a much higher relative permittivity than the potential analyte(s) of interest, such as methane and carbon dioxide. The adsorption of analytes is detected by monitoring the frequency of the mechanical resonator 11 that is coated with the sensing material 30. Adsorption of an analyte in the sensing material 30 increases the mass and lowers the frequency of the resonator and vice versa when the gas is desorbed.

U.S. Pat. No. 10,436,737 which is incorporated by reference herein in its entirety gives a suitable explanation of how to determine how much of the mass loading and resulting frequency shift is due to humidity (water molecules) in the sensing material 30, and how much is due to molecules of the target analyte, if any. To solve the humidity problem, two measurements are made on the same sensing material 30. First, the capacitance of the capacitor formed by the second and third electrodes 16 and 18 is measured to determine the amount of water in the sensing material 30. Second, the mechanical or electromechanical response (e.g., frequency shift) of the resonator 11 to mass loading is measured to determine the total combined mass of the gas absorption (analyte and water vapor) in the sensing material 30. The measurements of the oscillator response (e.g., frequency) and the capacitance may be taken at the same time or sequentially, and the order of measurements may be reversed.

Water usually has a much higher dielectric constant than the analyte(s) of interest, so the capacitance measurement signal corresponds to the amount of water in the sensing material 30 independent of the amount of analyte in the sensing material. Many gas analytes, such as methane and carbon dioxide, do not affect the capacitance, or their effect on the capacitance is negligible. The total combined mass adsorbed in the sensing material 30 corresponds to the sum of the mass of analyte plus the mass of water in the sensing material.

The capacitance measurement is used to calculate the contribution of water to the change in frequency (or whatever detection signal is chosen to measure the response of the oscillator if not frequency), and thus the contribution of water to the total combined mass adsorbed in the sensing material 30. The change in frequency of the resonator 11 indicates the combined mass adsorbed, and the contribution of water is subtracted (or accounted for using algorithms, calibration curves or data, and/or look-up tables) from the combined mass of the analyte plus water vapor adsorbed in the sensing material 30 to determine the amount of the analyte present, if any. In this way, the device is able to determine an accurate analyte value (e.g., mass or concentration) independent of humidity fluctuations.

FIG. 3 shows another embodiment of a sensor element having an oscillating portion and a capacitor positioned on the oscillating portion to measure the change in capacitance when water molecules are adsorbed in the sensing material 30. In this example, the sensor element includes four electrodes rather than three electrodes as previously described. As in the previous example, the sensor element includes the mechanical resonator 11 and first and second electrodes 14 and 16 coupled to opposite sides of the resonator 11. The first and second electrodes 14 and 16 are positioned to apply a potential difference across the resonator to drive an oscillating motion of the oscillating portion of the resonator 11.

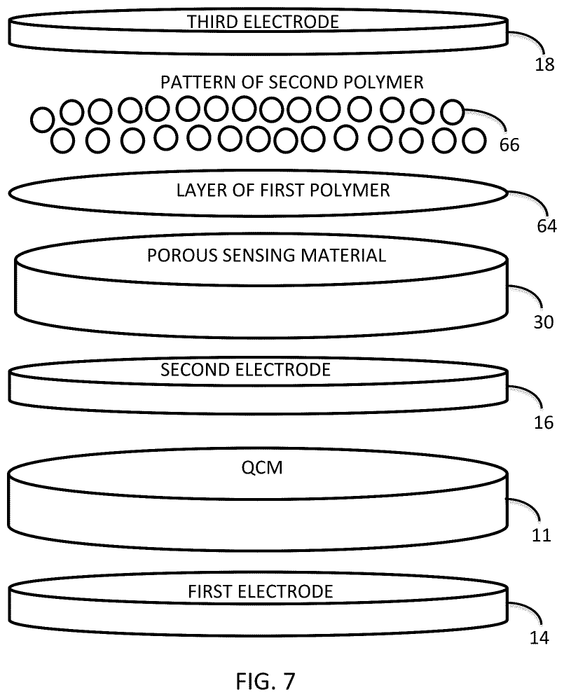

The capacitor is formed by third and fourth electrodes 24 and 26 with the sensing material 30 positioned between the third and fourth electrodes 24 and 26. In this example, the capacitor is preferably positioned on the oscillating portion of the resonator 11 by means of at least one insulating layer 28 that separates the third electrode 24 from the second electrode 16. Examples of suitable materials for the insulating layer include SiO₂, SiN, Al₂O₃ or AlN. The third and fourth electrodes 24 and 26 preferably comprise substantially parallel layers or plates of metal to form essentially a parallel plate type of capacitor. The fourth electrode 26 should be gas-permeable to ensure that the sensing material 30 is accessible to analytes and/or water vapor in a sample or environment to which the sensor is exposed. There are several methods for producing a gas-permeable electrode. A preferred porous metal electrode (gas-permeable) and technique for producing the electrode are described below with reference to FIGS. 7-14.

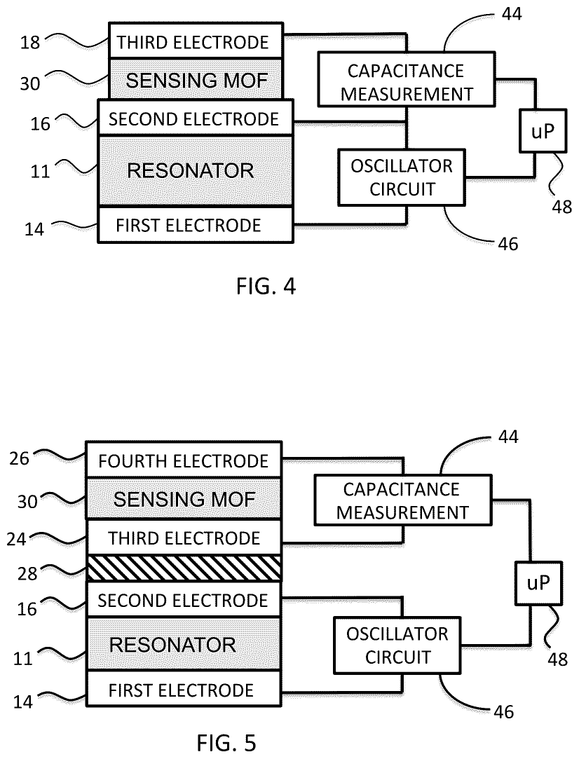

FIG. 4 is a schematic block diagram of an electronic readout circuit connected to a resonant sensor with a capacitor. In this example, the sensor device has three electrodes (as described above with reference to FIG. 2). There are many suitable ways to configure one or more readout circuits to measure both a response of the oscillating portion and a capacitance of the capacitor when substances are adsorbed or absorbed in the sensing material 30. Thus, the term “at least one readout circuit” includes embodiments in which both measurements are accomplished with a single electronic readout circuit, or other embodiments where separate electromechanical and capacitance measurements are accomplished by a plurality of separate readout circuits.

In this example, an oscillator circuit 46 is connected to the first electrode 14 and to the second electrode 16 to drive the oscillating motion of the resonator 11 and to measure a mechanical or electromechanical response of the oscillating portion when substances are adsorbed or absorbed in the sensing material 30. The sensing material is preferably a MOF film. Suitable oscillator circuits for the readout include the Colpitts, Pierce, or Butler oscillator circuits.

A capacitance measurement circuit 44 is connected to the second electrode 16 (shared electrode) and to the third electrode 18 to measure a capacitance of the capacitor formed by the second and third electrodes 16 and 18 when the substances are adsorbed or absorbed in the sensing material 30. The measurement of capacitance can be accomplished via a high-precision capacitance measurement method, such as but not limited to a relaxation oscillator or a Σ-Δ capacitance-to-digital converter. At least one processor 48 is in communication (wirelessly or with wires) with the oscillator circuit 46 and the capacitance measurement circuit 44 to receive signals or data indicative of the electromechanical response and the capacitance.

FIG. 5 is a schematic block diagram of a similar electronic readout circuit connected to a sensor element having four electrodes, rather than three electrodes. The oscillator circuit 46 is connected to the first electrode 14 and the second electrode 16 to drive the oscillating motion of the resonator 11 and to measure a mechanical or electromechanical response of the oscillating portion when substances are adsorbed or absorbed in the sensing material 30, preferably a MOF film. The capacitance measurement circuit 44 is connected to the third electrode 24 and the fourth electrode 26 to measure a capacitance of the capacitor formed by the third and fourth electrodes 24 and 26 when the substances are adsorbed or absorbed in the sensing material 30. The processor 48 is in communication with the oscillator circuit 46 and the capacitance measurement circuit 44 to receive signals or data indicative of the electromechanical response and the capacitance. Although the oscillator circuit 46 and capacitance measurement circuit 44 are drawn separately for simplicity of understanding in the patent drawings, they are typically part of the same overall electronic readout circuit under the control of the microprocessor 48.

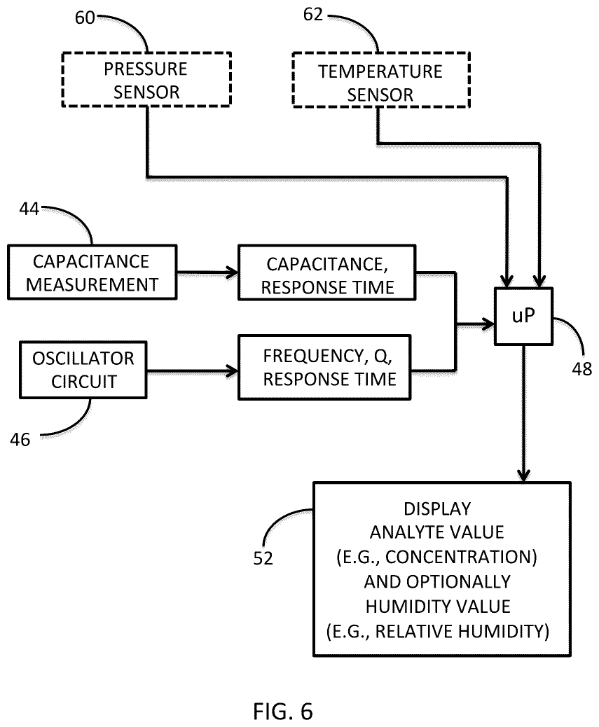

FIG. 6 is a schematic block diagram of the oscillator circuit 46 and the capacitance measurement circuit 44 communicating with the processor 48 that outputs a calculated analyte value and optionally a humidity value (e.g., a relative humidity value). The processor 48 is programmed to determine at least one analyte value indicative of the presence, amount or concentration of the analyte in dependence upon measurements of both the response of the oscillator 11 and the capacitance to account for the effects of water in the sensing material.

In some embodiments, the analyte value may be a binary value such as “PRESENT” or “ABSENT” for the analyte, or present above a desired limit or threshold. More preferably, the analyte value is a number such as a concentration, amount or mass of the analyte. The analyte and/or humidity values may optionally be displayed to an end-user via the display 52 in communication with the processor 48. In some embodiments, an optional pressure sensor 60 and an optional temperature sensor 62 (e.g., thermistor) may be connected to the microprocessor 48. The microprocessor 48 is programmed to determine capacitance vs. relative humidity (RH) at various temperatures (and optionally pressures).

There are many possible methods or algorithms in which measurements of both capacitance and response of the oscillating portion may be used to calculate the analyte value and optionally a humidity value. In general, the capacitance measurement indicates the amount of water in the sensing material or it indicates how much of the response of the resonator (e.g., frequency shift or resonance frequency, stiffness or strain) is due to water in the sensing material, and thus the processor 48 can calculate how much of the response of the resonator is due to a mass of the target analyte adsorbed or absorbed in the sensing material.

As one example, we may characterize capacitance vs. relative humidity (RH) at various temperatures (and optionally pressures). This characterization can be in the form of numbers or a mathematic formula such as a polynomial. We perform a similar characterization of resonant frequency vs. RH, also at various temperatures (and optionally pressures). Next, we combine these two datasets, and eliminate the variable RH, so that we have a database of calibration values with Capacitance vs. Resonant Frequency at various temperatures (and optionally pressures). For analytes such as methane and carbon dioxide, the target gases do not affect the capacitance, or their effect on the capacitance is negligible. Water has a strong effect on capacitance. The database of capacitance vs. resonant frequency is our water calibration database (e.g., a lookup table or mathematic formulas in the memory of the processor 48).

One example of a suitable algorithm is as follows: at each point in time, we measure the capacitance, convert the capacitance measurement to frequency using our calibration table, then subtract that frequency from the actual measured resonant frequency of the resonator. The result is a frequency change that corresponds only to the analyte of interest adsorbed in the sensing material. Optionally, we can take the capacitance measurement and convert it to RH using the calibration data table just described above. This way, the device reports both RH and analyte concentration, which may be displayed to an end-user via display 52, or otherwise communicated or recorded.

There are many other ways in which measurements of both capacitance and mechanical or electromechanical response of the oscillator may be used to calculate the analyte value and optionally a humidity value (typically by algorithms, calibration curves or calibration data, and/or look-up tables). Generally, the response of the oscillator (e.g., frequency response) indicates a combined mass of substances (water and analyte) adsorbed in the sensing material 30, and the capacitance measurement indicates the contribution of water to be subtracted (or accounted for) from the total combined mass of substances adsorbed or absorbed in the sensing material. Thus, the device is able to distinguish between water and analyte in the mass loading, and reports the analyte value accurately independent of humidity.

The processor 48 may be a microprocessor included with the device (e.g., a small 8 bit low-cost processor). Alternatively, processing functions may be performed in a separate processor or external computer in communication with the one or more readout circuits. The external processor or computer receives data representative of the measured capacitance and response of the oscillator (e.g. frequency shifts or resonance frequencies) and determines the analyte value and optionally humidity value. Alternatively, multiple processors may be provided, e.g., providing one or more processors in the device that communicate (wirelessly or with wires) with one or more external processors or computers.

Some processing of data can be done near the resonant sensor. For instance, time averaging or multiplexing or digitization can be all processed in the vicinity of the sensor before being transmitted to a computer or a circuit board with a multiprocessor. Specific algorithms can be loaded in memory to perform the same functions one would in a digital computer and then drive displays where colored outputs can be used to indicate level of detection or hazard. As in many sensors deployed today, such as RF tags and implanted medical devices, it is possible to use RF antennas to couple and provide power to the sensor. Once a sensor is powered, it senses its function, and then the output of the sensor is re-radiated to a receiving antenna. In this fashion, the device can be passive and remotely addressed.

FIG. 7 is an exploded view of a sensor element (similar to the sensor element previously described with reference to FIG. 2). The sensor element includes a resonator 11 (e.g., a QCM resonant sensor) with a first electrode 14 and a second electrode 16 coupled to opposite sides of the resonator. The sensing material 30 is preferably a porous crystalline material (e.g., a metal-organic framework material) that is grown or deposited directly on the second electrode 16. The third electrode 18 is gas-permeable and used as the outer electrode in a capacitor formed by the second and third electrodes, with the sensing material 30 positioned between the second electrode 16 and the third electrode 18. The three electrodes allow both resonant and capacitive measurements of analyte and humidity values as previously described. The gas permeable electrode 18 has small cracks, discontinuities, pores, voids, interstices and/or holes that allow one or more analytes (e.g., molecules of target gas or liquid) to pass through the electrode 18 and be captured in the sensing material 30.

The electrode 18 typically has a thickness in the range of 4 to 300 nm nanometers in embodiments that include a resonant sensor (e.g., a QCM). In other embodiments without a resonant sensor, just measuring capacitance between electrodes, the electrode might be thicker than 300 nm. The gas-permeable electrode 18 is composed of an electrically conductive metal. Suitable conductive materials include for example aluminum, nickel, titanium, tin, indium-tin oxide, gold, silver, platinum, palladium, copper, chromium and combinations thereof.

A preferred method for producing a porous metal electrode (gas-permeable) will now be described. At least one layer of a first polymer 64, which is a gas-permeable polymer, is applied over a surface of the sensing material 30. Preferably, the first polymer 64 forms a continuous film or coating over the sensing material 30. The first polymer 64 is preferably applied via spin coating of a solution containing the first polymer. The layer of the first polymer 64 has a thickness that is typically in the range of 10 to 300 nm. The first polymer 64 is preferably polytetrafluoroethylene (PTFE); or a fluorinated polymer; or a fluorinated polymer and copolymers (e.g., Teflon Amorphous Fluoropolymer) forming a continuous coating over a surface of the sensing material 30.

Small blobs, islands, dots, or bumps 66 of a second polymer are produced on the exposed surface of the first polymer 64. The second polymer is immiscible with the first polymer, and the second polymer is applied over a surface of the first polymer (e.g., by spray-dry deposition of the second polymer). The bumps 66 of the second polymer provide a polymeric template that will cause corresponding cracks, discontinuities, pores, voids, interstices or holes to form in the gas-permeable electrode 18 when it is deposited as a metal layer over the layer of the first polymer and bumps of the second polymer.

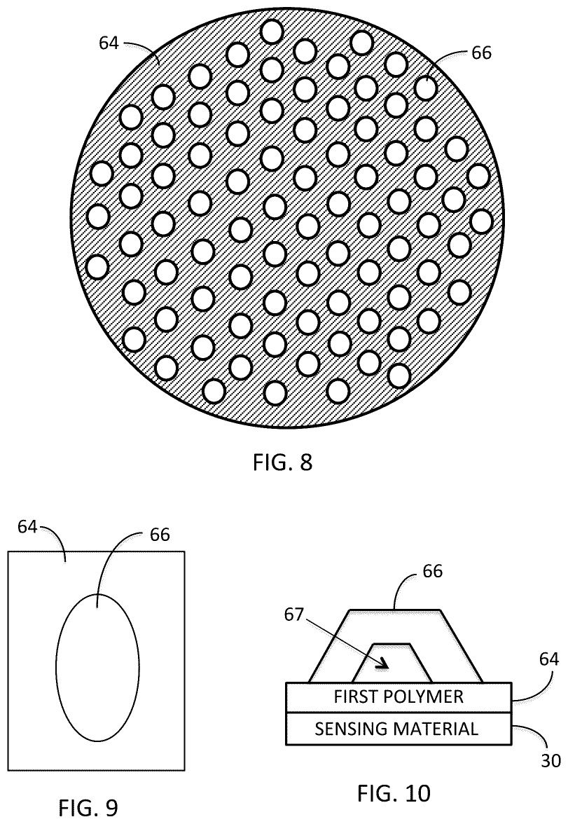

FIG. 8 is a schematic plan view showing an example of a pattern of blobs or bumps 66 composed of the second polymer disposed (e.g., by spray-dry deposition) on the surface of the continuous coating of the first polymer 64. The incompatibility/immiscibility between the first polymer and the second polymer leads to segregation of the second polymer into a pattern of discontinuous blobs, islands, dots or bumps 66 on the continuous layer of the first polymer 64. The bumps 66 of the second polymer provide a polymeric template that will cause corresponding cracks, discontinuities, pores, voids, or holes to form in the metal electrode when it is deposited as a layer of metal over the bumps 66 of the second polymer and the surface area of the first polymer 64 between the bumps. The second polymer 66 is preferably polyvinyl pyridine (PVP) or polyvinyl pyrrolidone.

FIG. 9 shows an example of a blob or bump 66 of the second polymer on the surface of the continuous coating of the first polymer 64. The height of the bump 66 (extending out of the paper in FIG. 9) is preferably in the range of 100 nm to 5 μm. In some embodiments, the height of each bump 66 is in the range of 100 nm to 2 μm. The length of each bump 66 is preferably in the range of 1 to 20 μm. The width or diameter of each bump 66 is also preferably in the range of 1 to 20 μm.

FIG. 10 shows a side view of a blob or bump 66 of the second polymer on the surface of the first polymer 64 (gas-permeable) which in turn coats the sensing material 30. Some of the blobs or bumps may form with a hollow morphology, so that the bumps have a hollow interior with open side spaces, while some bumps or blobs may be solid. In this example, the bump 66 has side openings 67 and a hollow interior space. Thus, there is an uncovered area underneath the bump (not covered by the second polymer) that is accessible through the side openings 67 of the hollow bump so that analyte can diffuse through when corresponding cracks, discontinuities, interstices, holes or voids are formed in the metal electrode layer around the bases of the bumps.

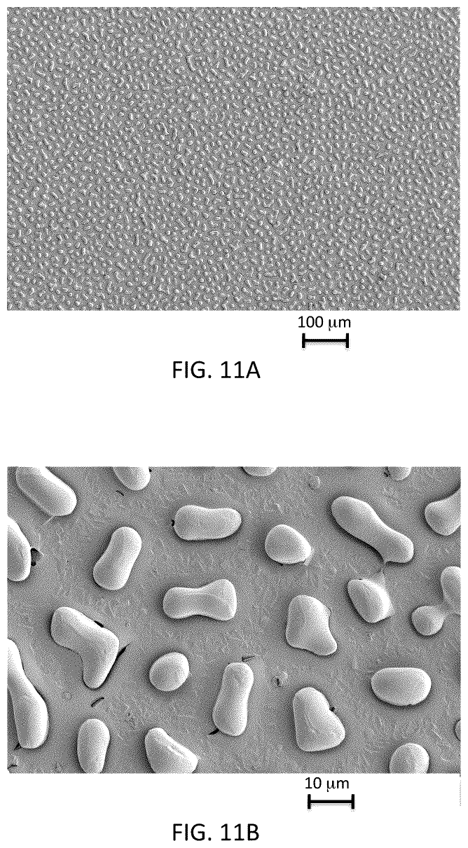

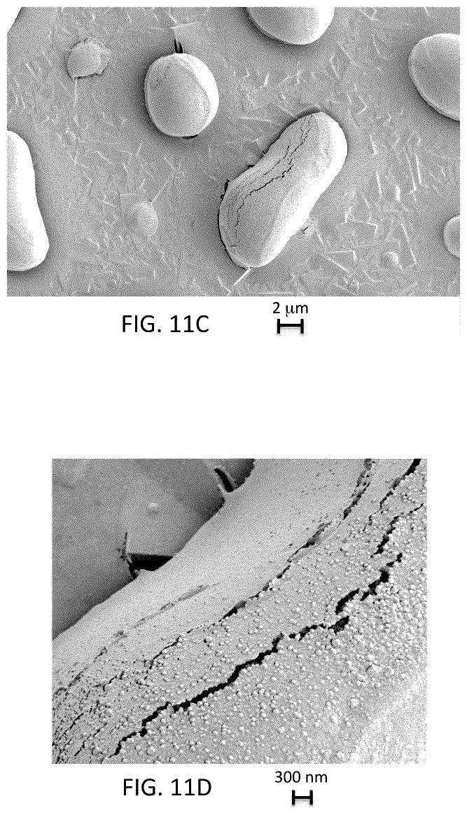

Referring again to FIGS. 7-8, the metal electrode 18 comprises at least one layer of an electrically conductive metal that is deposited (e.g., sputtered or evaporated) over the blobs or bumps 66 of the second polymer and the exposed surface area of the first polymer 64 between the bumps. The polymeric template provided by the bumps 66 of the second polymer promotes small cracks, discontinuities, pores, voids, interstices or holes in the metal electrode layer that enable fast diffusion of analytes through the electrode 18. The cracks, discontinuities, or voids form in the metal electrode 18 due to the expansion/contraction of a flexible, porous, and soluble material such as the second polymer within a rigid and insoluble coating of the deposited metal layer, and the differences of the expansion coefficient of the two different materials (the metal layer and the second polymer). The most important cracks, discontinuities or voids typically form in the metal layer around the bases (outlines) of the bumps 66, although some less important cracks may form in the portions of the metal layer deposited between the bumps and on top of the bumps as shown in the SEM images of FIGS. 11A-11D.

Referring again to FIGS. 8-10, the cracks, discontinuities or voids in the metal electrode layer permit analyte to diffuse into the sensing material 30. The most important cracks, discontinuities or voids typically form in the metal layer around the base of each bump 66, allowing analyte to pass through the layer of the gas-permeable polymer 64 and into the sensing material 30.

FIGS. 11A-11D are SEM images showing increasingly closer views of a metal electrode (e.g., gold) deposited over the polymeric template provided by the continuous coating of the first polymer and the blobs or bumps of the second polymer. FIG. 11A shows the layer of gold deposited (e.g., sputtered or evaporated) over the polymer template provided by the first and second polymers. FIGS. 11B-C show good views of the most important cracks, discontinuities or voids that form in the metal layer around the perimeter of the bases of the bumps (i.e., around the outlines of the bumps). Some less important cracks may form in the portions of the metal layer deposited between the bumps and on top of the bumps. FIG. 11D shows a close-up view of cracks, discontinuities or voids formed at the base of a bump and on top of the bump.

Some cracks, discontinuities or voids in the metal layer complete a loop around the entire perimeter of the base (outline) of a bump. Other cracks, discontinuities or voids form around the base of the bump but only partially encircle the perimeter of the base. These cracks, discontinuities or voids in the metal layer, that form at the bases of the bumps but do not encircle all the way around the perimeter of the bases, are still sufficient for analyte diffusion. Some of the cracks or voids are submicron in size, smaller than the dimensions of the bumps, particularly the cracks and voids formed between the bumps, while other cracks or voids are closer to the dimensions of the bumps (e.g., 1 to 20 μm in the length) and form on top of the bumps or around the bases of the bumps (i.e., around the outlines of the bumps).

Most of the cracks, discontinuities or voids in the metal layer typically form around the bases (outlines) of the bumps 1-20 μm in length, and these cracks, discontinuities or voids allow the most analyte to diffuse through the electrode. To a certain extent, exact dimensions are irrelevant, because gas will freely diffuse through any opening having a size greater then a few 10s of nanometers (e.g., greater than 20 to 30 nm) under most operating conditions. The cracks, discontinuities or voids in the metal layer can be over 1 μm and do the same job as submicron cracks, discontinuities or voids to a certain extent. The cracks, discontinuities or voids in the metal layer encircling the bases (outlines) of the bumps, at least partially, are much larger than that (e.g., 1 to 20 μm in the length or greater).

An optional method step is exposing the sensor element to moisture to promote cracking or voids in the metal electrode via swelling of the bumps of the second polymer due to hydration. In some embodiments, the assembly is exposed to moisture (e.g., in the ambient atmosphere after the metal layer is deposited in vacuum). The bumps of the second polymer swell with water after being completely dry (contracted) during the metal deposition under vacuum. We found that more cracking of the metal layer is promoted by the swelling of the polymer bumps, and just moisture in the ambient air or atmosphere is often sufficient.

The cracks, discontinuities, or voids form in the metal electrode due to the expansion/contraction of a flexible, porous, and soluble material such as the second polymer within a rigid and insoluble coating of the deposited metal layer, and the differences of the expansion coefficient of the two different materials (the metal layer and the second polymer). Some bumps rise or pop up because of the swelling with hydration, which further promotes the formation of cracks, discontinuities, or voids, particularly around the bases (outlines) of the bumps. Lateral expansion via swelling also leads to small cracks at the tops of the bumps.

Referring again to FIG. 8, the islands or bumps 66 of the second polymer that are patterned on a surface of the continuous layer of the first polymer 64 (e.g., by spray drying the second polymer in a solution) preferably cover at least 5 to 10% of the surface area of the layer of the first polymer 64. More preferably, the islands or bumps 66 of the second polymer cover at least 20%, 30% or 50% of the total surface area of the continuous layer of the first polymer 64. A higher amount of surface area covered by the bumps 66 of the second polymer leads to the creation of more cracks or voids in the gas permeable electrode for a faster diffusion rate of the gas/liquid analyte across the metal electrode (or faster response time of the sensor element), but we do not want to create so many cracks or voids in the gas permeable electrode that it fails to function as an effective electrode. For instance, you can have high surface area coverage but a low number of bumps per electrode area, then gas permeating pathways will be very reduced. On the other hand, if you have high surface area coverage and high number of bumps (and then higher total distance around the perimeters of the bases of the bumps where the best cracks and discontinuities form in the metal layer), then the diffusion across the porous electrode will be superior.

The pattern, spacing and dimensions of the cracks, discontinuities, pores, or voids in the metal electrode are typically the same as the pattern, spacing and dimensions of the bumpy polymer pattern (provided by the bumps of the second polymer disposed over the continuous coating of the first polymer). The resulting metal electrode that forms when metal is deposited over the polymer template provided by the first and second polymers has the same shape/porosity as the “bump footprint” or “polymeric template” with most of the cracks, discontinuities, pores, or voids in the metal electrode forming around the bases of the bumps (i.e., around the outlines of the bumps). The spacing, coverage and dimensions of the bumps of the second polymer that are patterned on the continuous coating of the first polymer can be controlled (e.g., selection of the concentration of the second polymer, solvent, spray drying conditions, temperatures) to precisely tune the number, spacing and sizes of the bumps and corresponding cracks, discontinuities or voids in the metal electrode and thus the diffusion rate of the gas/liquid analyte across the metal electrode (or response time of the sensor element).

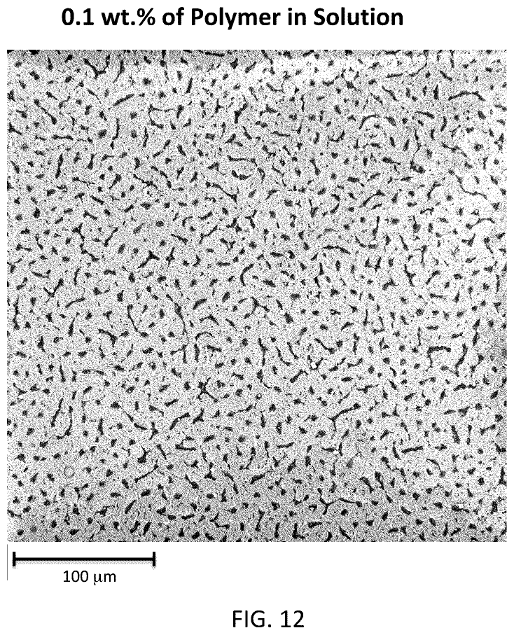

FIG. 12 is an SEM image showing a first example of the second polymer forming discontinuous blobs or bumps on the continuous layer of the first polymer. The concentration is 0.1 wt. % of the second polymer in a solution of MeOH that was directly spray dried for 3 minutes over the continuous coating of the first polymer at room temperature. The total surface area of the continuous coating of the first polymer in this example is 148,196 square microns (μm²). This will also be the surface area of the top surface (and bottom surface) of the metal electrode when deposited (no metal deposited yet in FIG. 12). There are 1,307 blobs or bumps of the second polymer, and the bumps cover about 9.2% of the total surface area of the layer of the first polymer. A high number of bumps (and thus higher total distance around the bases of the bumps where the best cracks, discontinuities or voids form in the metal layer) permits excellent diffusion of analyte across the resulting metal electrode. In this example, the total distance around the perimeters of the bases (outlines) of the 1,307 bumps is about 27,356 μm, so that the ratio of the distance around the perimeters of the bases of the bumps to the total surface area of the layer of the first polymer (and top surface area of the resulting metal electrode when deposited) is 0.184597908 perimeter/Surface Area (μm⁻¹).

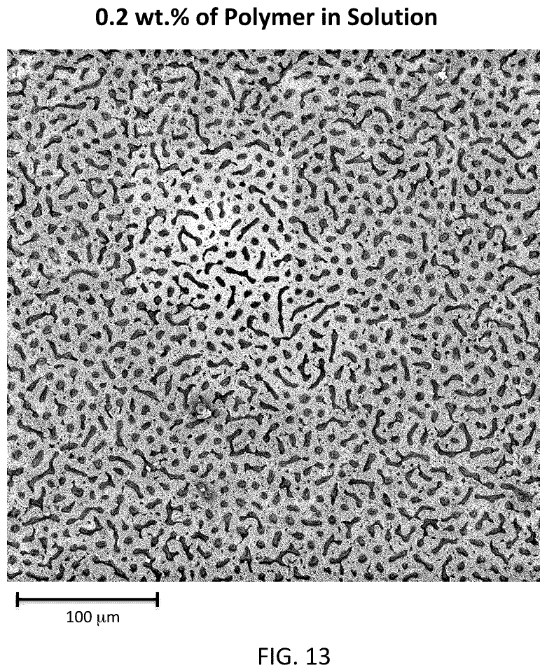

FIG. 13 is an SEM image showing a second example of the second polymer forming blobs or bumps on the continuous layer of the first polymer. The concentration is 0.2 wt. % of the second polymer in a solution of MeOH that was directly spray dried for 3 minutes over the continuous coating of the first polymer at room temperature. The total surface area of the continuous coating of the first polymer in this example is 148,196 square microns (μm²). This will also be the surface area of the top surface (and bottom surface) of the metal electrode when deposited (no metal deposited yet in FIG. 13). There are 1,497 blobs or bumps of the second polymer, and the bumps cover about 21.5% of the total surface area of the continuous layer of the first polymer. In this example, the total distance around the perimeters of the bases (i.e., outlines) of the 1,497 bumps is about 46,130 μm, so that the ratio of the distance around the perimeters of the bases of the bumps to the total surface area of the layer of the first polymer (and top surface area of the resulting metal electrode when deposited) is about 0.311277017 perimeter/Surface Area (μm⁻¹).

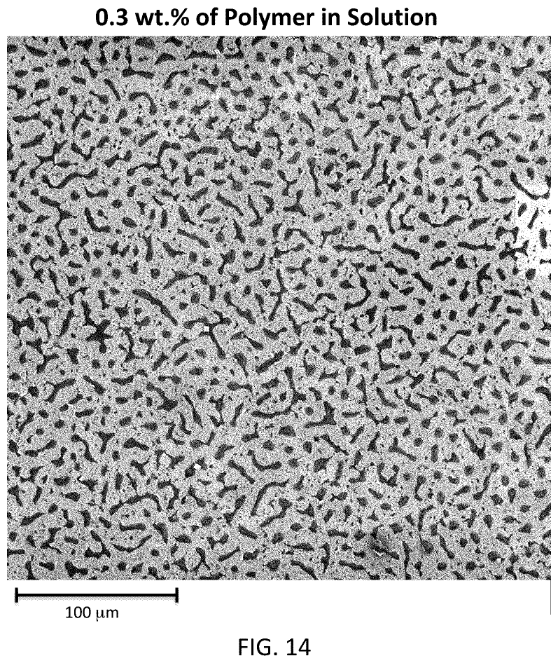

FIG. 14 is an SEM image showing a third example of the second polymer forming blobs or bumps on the continuous layer of the first polymer. The concentration is 0.3 wt. % of the second polymer in a solution of MeOH that was directly spray dried for 3 minutes over the continuous coating of the first polymer at room temperature. The total surface area of the continuous coating of the first polymer in this example is 148,196 square microns (μm²). This will also be the surface area of the top surface (and bottom surface) of the metal electrode when deposited (no metal deposited yet in FIG. 14). There are 1,284 blobs or bumps of the second polymer, and the bumps cover about 18.7% of the total surface area of the continuous layer of the first polymer. In this example, the total distance around the perimeters of the bases (i.e., outlines) of the 1,284 bumps is about 43,362 μm, so that the ratio of the distance around the perimeters of the bases of the bumps to the total surface area of the layer of the first polymer (and top surface area of the resulting metal electrode when deposited) is about 0.2926019 perimeter/Surface Area (μm⁻¹).

Table 1 shows a summary of the parameters disclosed in the previous 3 examples.

TABLE 1

| | Polymer | Area | | Perimeter of | |
|---|---|---|---|---|---|
| | concentration | Coverage | Number of | bump bases | perimeter/Area |
| Example | (%) | (%) | Bumps | (μm) | (μm⁻¹) |
| 1 (FIG. 12) | 0.1 | 9.2 | 1307 | 27356 | 0.184597908 |
| 2 (FIG. 13) | 0.2 | 21.5 | 1497 | 46130 | 0.311277017 |
| 3 (FIG. 14) | 0.3 | 18.7 | 1284 | 43362 | 0.2926019 |

In general, a high number of bumps per unit surface area (and thus high total distance around the perimeters of the bases of the bumps per unit surface area) permits fast and effective diffusion of analyte across the resulting metal electrode and faster response time of the sensor. The ratio of the distance around the perimeters of the bases of the bumps (i.e., around the outlines of the bumps) to the total surface area of the layer of the first polymer (which will be the same surface area of the resulting metal electrode when deposited) is preferably at least 0.1, more preferably at least 0.2, and most preferably greater than or equal to 0.3 perimeter/Surface Area (μm⁻¹).

Most cracks, discontinuities or voids in the metal layer complete a loop around the entire perimeter of the base of a bump. Other cracks, discontinuities or voids form around the base of the bump but only partially encircle the perimeter of the base. These cracks, discontinuities or voids in the metal layer, that form at the bases of the bumps, but do not encircle all the way around the perimeter of the bases, are still sufficient for analyte diffusion. Assuming that each of the cracks, discontinuities or voids in the metal electrode forms on average at least halfway around the base of the bump (probably more than that), then the ratio of the total lengths of the cracks, discontinuities or voids in the metal electrode to the total surface area of the top (or bottom) surface of the metal electrode is preferably at least 0.05, more preferably at least 0.1, and most preferably greater than or equal to 0.15 perimeter/Surface Area (μm⁻¹).

In general, the concentration of the second polymer in solution depends on the solubility of the selected polymer in the selected solvent. It is preferably in the range of 10 to 100 times dilution of the polymer solubility (maximum amount of polymer that can be dissolved in a given amount of solvent at given temperature) in MeOH to achieve homogeneous dispersion by spray drying. Spray drying conditions (time, distance) depend on the polymer concentration and the type of spray gun that is used for applying bumps of the second polymer.

Another parameter is the maximum distance between bumps, and thus the corresponding maximum distance between cracks in the metal electrode. There are many factors that contribute to the ideal bump spacing, and thus the corresponding spacing between cracks, discontinuities, pores, or voids in the metal electrode. One consideration is response time which is dictated by diffusion in the sensing material. So spacing of the bumps and corresponding cracks or voids in the metal electrode layer depends on the diffusion rate in the sensing material and the desired response time. We prefer center-to-center spacing in the range of 100 nm to 100 microns for the bumps and corresponding cracks or voids in the metal electrode that are shaped like the bases of the bumps. In some embodiments, a specific target is <5 μm (ideally) spacing between the edges of the bases of the bumps. In other examples of operation, the use of other materials or other desired response times could imply different spacing.

We prefer a homogeneous dispersion of the pattern or “micro-pattern” of bumps. It is possible to spray blobs of a second polymer on a surface of the first polymer somewhat randomly. More preferably, there is fairly uniform spacing of bumps of the second polymer across the surface of the first polymer. Patterns can be regular or irregular, and either would provide a gas-permeable metal electrode. A fairly homogeneous dispersion of the pattern of bumps with substantially uniform spacing results in the metal electrode having excellent resonance properties when used in embodiments that include a resonant sensor or sensor stack. The Q-value of the metal electrode is greater than 1,000 and more preferably greater than 40,000 for resonant embodiments. The Q-value may be of lesser importance in embodiments where the gas permeable electrode is an outer electrode in a capacitor, without a resonant sensor.

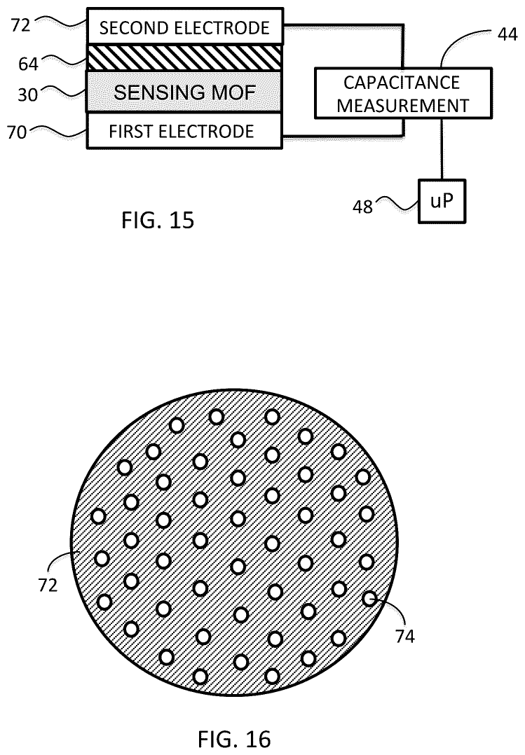

FIG. 15 shows another embodiment of the invention where the gas permeable electrode is used as an outer electrode in a capacitor, without a resonant sensor. The capacitive sensor element has a first electrode 70 and a second electrode 72 that is the porous metal electrode (gas-permeable). The sensing material 30 is positioned between the electrodes. Electronics or electrical circuits function to determine the change in capacitance between the electrodes due to adsorption or desorption of analyte in the sensing material 30 so that an analyte value or humidity value can be determined. For example, the capacitance measurement circuit 44 is connected to the first electrode 70 and to the porous metal electrode 72 to measure a capacitance of the capacitor formed by the electrodes when substances are adsorbed or absorbed in the sensing material 30. The measurement of capacitance can be accomplished via a high-precision capacitance measurement method, such as a relaxation oscillator or a Σ-Δ capacitance-to-digital converter. FIG. 15 demonstrates the utility of the gas permeable electrode in a two-electrode sensor element, or in any other embodiment where a gas permeable electrode is required to permit analyte to pass through the electrode to a sensing material 30.

FIG. 16 is a schematic plan view illustrating another optional step of removing the bumps of the second polymer after the metal electrode 72 is deposited. The bumps of the second polymer can be partially or completely removed by dissolving them away in solvents; or the bumps can be sanded down by plasma etching; or the bumps can be partially or mostly removed by mechanical procedures. In some examples, the bumps can be thermically (thermally) evaporated. Other removal methods like supercritical CO₂ may lead to excellent removal of the PVP bumps without altering the rest of the sensor stack. In some embodiments, the polymer can be changed with a molecule having a low boiling point, or a thermally unstable polymer that can break in monomers with temperature and be evaporated.

The optional step of removing, shaving, or flattening the bumps of second polymer also sometimes remove the portions of the electrically conductive metal layer that was covering the bumps, so that the additional holes 74 are formed in the metal electrode 72. The additional holes 74 typically have the size and shape of the removed bumps of the second polymer. The dimensions of the additional holes 74 in the porous metal electrode 72 are generally the same as the dimensions of the bumps of the second polymer. Referring again to FIG. 10, the coating layer of the first polymer 64 is generally left intact even when the bumps 66 of the second polymer are removed. Referring again to FIG. 15, the first polymer 64 is gas-permeable to permit analyte (e.g., molecules of a target gas or liquid) to pass through the porous metal electrode 72 and through the layer of the first polymer 64 to reach the sensing material 30 where the analyte is captured.

It is not necessary to remove the bumps of the second polymer, because the gas-permeable electrode 72 already has cracks, discontinuities, voids, or pores after it is deposited due to the bumps. Removing the bumps of the second polymer may improve Q-value of the metal electrode. Another reason to remove the polymer bumps is to prevent the possibility that the bumps adsorb water during operation of the sensor which may compromise the performance of the sensor.

The above description illustrates embodiments of the invention by way of example and not necessarily by way of limitation. Many other embodiments are possible. For example, both the first and second polymers may be selected from a wide range of polymers to display (or not) an additional role in the capacitor sensor stack (e.g., surface passivation, pinhole fillers, insulator, gas buffer, anti-cracking, adhesive layer, etc.). In some embodiments, if the bumps of the second polymer are removed, leaving additional holes or gaps in the metal electrode, then it may be of additional interest to re-sputter the gap with other metal to make bi-metal electrodes.

In some embodiments, this disclosure provides computer systems comprising hardware (e.g. one or more processors or microprocessors and associated memory) programmed to perform the methods or functions described herein, as well as computer-readable media encoding instructions to perform the steps described. In some embodiments, a look-up table, calibration curve or function is used to determine the quantity of each substance of interest (e.g., a target gas like CO₂), according to the signals or data indicating the transducer responses. The look-up table, calibration data, or function may be in one or more processors and associated memory included with the sensor device. In some embodiments, an on-board microprocessor is programmed to perform temperature control, demodulation functions, regressive analysis (e.g., curve-fitting), or store measured signal values and/or to determine gas quantities. Alternatively, at least some of these steps or functions may be performed in a separate processor or external computer in communication with the sensor element, with or without wires. In other embodiments, the sensor has only some signal processing electronics, and some determination and calculation functions are performed in a separate processor or external computer in communication with the sensor.

For simplicity in patent drawings, a single controller or microprocessor is described herein. It is to be understood that the sensor device may include multiple processors and/or associated memories, as well as analog or digital circuits. In some embodiments, at least one on-board microprocessor or controller receives capacitor or transducer measurement signals/data and temperature measurement signals/data, either through direct connections or indirectly through one or more additional signal processing circuits or processor components. For example, the signal demodulation function can be performed by several methods, implemented as an analog or digital circuit, or in software of a processor.

Only one sensor element was shown at a time for simplicity of understanding in the patent drawings, but arrays of sensors are also possible in alternative embodiments. Arrays of transducers may be functionalized with MOFs or other sensing materials having different properties so that the sensor array can sensitively detect and differentiate multiple target analytes, chemical compounds, and even complex mixtures.

Accordingly, the scope of the invention should be determined by the following claims and their legal equivalents.

What is claimed is:

1. A method for fabricating a gas permeable electrode, the method comprising:
a) coating a sensing material with at least one layer of a first polymer, wherein the first polymer is gas-permeable;
b) producing bumps or blobs of a second polymer on a surface of the first polymer;
c) depositing at least one layer of an electrically conductive metal over the bumps of the second polymer and the exposed surface area of the first polymer between the bumps to form the metal electrode, wherein the metal electrode forms cracks, discontinuities, voids, or interstices caused by the interaction of the deposited metal layer with the bumps of the second polymer.

2. The method of claim 1, wherein the sensing material comprises a porous crystalline material.

3. The method of claim 1, wherein the bumps or blobs of the second polymer are patterned on the surface of the first polymer by spray drying the second polymer in a solution.

4. The method of claim 3, wherein the first polymer is immiscible with the second polymer so that the second polymer forms a pattern of discontinuous bumps, dots, islands or blobs on the surface of the first polymer.

5. The method of claim 1, further comprising the step of exposing the gas permeable electrode to moisture to promote further cracking in the metal layer due to swelling of the bumps of the second polymer due to hydration.

6. The method of claim 1, wherein the bumps of the second polymer are produced on the surface of the first polymer such that the bumps cover at least 5 to 10% of the surface area of the layer of the first polymer.

7. The method of claim 1, wherein the bumps of the second polymer are produced on the surface of the first polymer such that the bumps cover at least 10 to 20% of the surface area of the layer of the first polymer.

8. The method of claim 1, wherein each of the bumps of the second polymer has a height in the range of 100 nm to 5 μm, a length in the range of 1 to 20 μm, and a width or diameter in the range of 1 to 20 μm.

9. The method of claim 1, wherein the ratio of the total distance around the perimeters of the bases of the bumps to the surface area of the layer of the first polymer is at least 0.18 perimeter/Surface Area (μm⁻¹).

10. The method of claim 1, further comprising the step of partially or completely removing the bumps of the second polymer after the metal layer is deposited.

11. A sensor element comprising:
a) a sensing material;
b) at least one layer of a first polymer coating the sensing material, wherein the first polymer is gas-permeable;
c) bumps, islands or blobs of a second polymer disposed on a surface of the first polymer; and
d) at least one layer of an electrically conductive metal deposited over the bumps of the second polymer and surface areas of the first polymer between the bumps, wherein the metal layer has cracks, discontinuities, voids, or interstices formed at the bases of the bumps.

12. The sensor element of claim 11, wherein the sensing material comprises a porous crystalline material (e.g., a metal-organic framework).

13. The sensor element of claim 11, wherein the second polymer is arranged in a pattern of at least 100 discontinuous bumps, blobs or islands on the surface of the first polymer.

14. The sensor element of claim 11, wherein the bumps of the second polymer cover at least 9% of the surface area of the layer of the first polymer.

15. The sensor element of claim 11, wherein the bumps of the second polymer cover at least 15% of the surface area of the layer of the first polymer.

16. The sensor element of claim 11, wherein each of the bumps of the second polymer has a height in the range of 100 nm to 5 μm, a length in the range of 1 to 20 μm, and a width or diameter in the range of 1 to 20 μm.

17. The sensor element of claim 11, wherein the ratio of the total distance around the perimeters of the bases of the bumps to the surface area of the layer of the first polymer is at least 0.18 perimeter/Surface Area (μm⁻¹).

18. A gas permeable electrode comprising at least one layer of an electrically conductive metal having cracks, discontinuities, or voids that are shaped like the full or partial outlines of blobs or bumps, wherein the ratio of the total lengths of the cracks, discontinuities or voids in the metal layer to the total surface area of the top (or bottom) surface of the metal layer is at least 0.05 total length/surface area (μm⁻¹).

19. The gas permeable electrode of claim 18, wherein the metal layer has at least 100 cracks, discontinuities, or voids that are shaped like the full or partial outlines of blobs or bumps, and the ratio of the total lengths of the cracks, discontinuities or voids in the metal layer to the total surface area of the top (or bottom) surface of the metal layer is at least 0.1 total length/surface area (μm⁻¹).

20. The gas permeable electrode of claim 18, wherein the metal layer has at least 200 cracks, discontinuities, or voids that are shaped like the full or partial outlines of blobs or bumps, and the ratio of the total lengths of the cracks, discontinuities or voids in the metal layer to the total surface area of the top (or bottom) surface of the metal layer is at least 0.15 total length/surface area (μm⁻¹).
